(19) United States
(12) Patent Application Publication
(10) Pub. No.: US 2024/0405568 A1
(43) Pub. Date: Dec. 5, 2024

(54) SYSTEM AND METHOD FOR CLEAN ENERGY PLANNED MICROGRID SEAMLESS TRANSITIONS

(71) Applicant: AES Clean Energy Services, LLC, Arlington, VA (US)

(72) Inventors: Alston D Costa, Lakewood, CO (US); Ankit Sharma, Longmont, CO (US); Christopher Boyer, Grand Prairie, TX (US); Samuel Ley, Boulder, CO (US); Felipe Cantero, Arvada, CO (US)

(73) Assignee: AES Clean Energy Services, LLC, Arlington, VA (US)

(21) Appl. No.: 18/731,686

(22) Filed: Jun. 3, 2024

Related U.S. Application Data
(60) Provisional application No. 63/470,619, filed on Jun. 2, 2023.

(51) Int. Cl. H02J 3/38; H02J 3/16

(52) U.S. Cl. CPC H02J 3/388; H02J 3/16

(57) ABSTRACT

A method and system for transitioning between grid-tied and islanded modes of operation are disclosed. A plant may include a microgrid that includes one or more customer loads and that may provide power to a utility grid. The plant may include clean energy sources, such as DC-coupled photovoltaics and battery systems, as well as other types of clean energy generation and storage technologies. In certain instances, the plant may transition from grid-tied (in which the plant receives or provides power to the utility grid) to islanded (where the plant is disconnected from and does not receive or provide power to the utility grid), and vice-versa. The method and system may automatically transition between grid-tied and islanded without interruption of power to the one or more customer loads.

### REFERENCE TO RELATED APPLICATIONS

The present application claims priority to U.S. Provisional Application Ser. No. 63/470,619 (filed on Jun. 2, 2023), which is incorporated by reference herein in its entirety. This application is related to US Application No. ______ entitled System and Method for Automated Clean Energy Blackstart for Backup Auxiliary Power, Microgrid Customer Loads, and Utility Grid (attorney ref. no. 10417-23005B (P00043)), incorporated by reference herein in its entirety.

### FIELD OF THE INVENTION

The present application relates generally to seamless microgrid transitions, such as from grid-tied mode to islanded mode and from islanded mode to grid-tied mode of operation.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

A power grid (interchangeably termed a grid or a macrogrid) is an interconnected network for electricity delivery from producers to consumers. Power grids typically include: power stations (interchangeably a power plant, generating station, or generating plant) that generate power; electrical substations (interchangeably termed substations) that step the voltage up or down; and electrical power distribution where the voltage is stepped down again to the required service voltage(s) for the end customers.

In certain instances, the power grid may work in combination with a microgrid, which may comprise a local electrical grid with defined electrical boundaries that acts as a single and controlled entity. A specific type of microgrid is a stand-alone microgrid, which has its own source of electricity (e.g., generation sources and/or energy storage, such as batteries). The microgrid may operate in different modes of operation, such as grid-tied (interchangeably termed grid-connected) or islanded (interchangeably termed in island mode). A grid-tied microgrid may operate connected to and synchronous with the power grid (e.g., the macrogrid). The islanded microgrid may be electrically disconnected from the power grid and may function autonomously from the power grid with local loads connected in circuit. In this regard, the microgrid may transition from grid-tied to islanded and vice-versa.

### SUMMARY

In one or some embodiments, a method for transitioning a plant between grid-tied and islanded is disclosed. The plant includes at least one microgrid supplying power to one or more customer loads, wherein the plant when grid-tied is providing to or receiving power from at least a part of a grid that is operated by a utility, and wherein the plant when islanded is disconnected from providing or receiving power to the at least a part of the grid. The method includes: responsive to an indication to transition the plant between grid-tied and islanded: performing one or more checks prior to the transition, the one or more checks comprising: for the transition from grid-tied to islanded: determining an amount of power provided to the grid and an amount of power provided to the one or more customers of the plant; or for the transition from islanded to grid-tied: determining, by the plant, whether sensed frequency, sensed voltage and sensed phase angle on both sides of the at least one islanding breaker is within a predetermined tolerance; responsive to performing the one or more checks prior to the transition, determining whether to perform one or more actions, the one or more actions comprising: for the transition from grid-tied to islanded: responsive to determining the amount of power provided to the grid and the amount of power provided to the one or more customers of the plant, modifying power output of the plant to be the amount of power provided to the one or more customers loads of the at least one microgrid; or for the transition from islanded to grid-tied: responsive to determining by the plant that the sensed frequency, the sensed voltage, and the sensed phase angle on both sides of the at least one islanding breaker are not within the predetermined tolerance, performing at least one action so that the sensed frequency, the sensed voltage, and the sensed phase angle on both sides of the at least one islanding breaker are within the predetermined tolerance; and after determining whether to perform the one or more actions and performing the one or more actions, causing the at least one islanding breaker to change its state thereby transitioning the plant between grid-tied and islanded.

In one or some embodiments, a plant configured to supply power to one or more customer loads and to supply the power to or receive the power from a grid that is operated by a utility is disclosed. The plant includes: at least one microgrid configured to supply the power to the one or more customer loads; communication functionality configured to communicate with the utility; and at least one controller. The at least one controller is configured to: control the power supplied by the at least one microgrid to the one or more customer loads; responsive to an indication to transition the plant between grid-tied and islanded: perform one or more checks prior to the transition, the one or more checks comprising: for the transition from grid-tied to islanded: determining an amount of power provided to the grid and an amount of power provided to the one or more customers of the plant; or for the transition from islanded to grid-tied: determining, by the plant, whether sensed frequency, sensed voltage and sensed phase angle on both sides of the at least one islanding breaker is within a predetermined tolerance; responsive to performing the one or more checks prior to the transition, determine whether to perform one or more actions, the one or more actions comprising: for the transition from grid-tied to islanded: responsive to determining the amount of power provided to the grid and the amount of power provided to the one or more customers of the plant, modifying power output of the plant to be the amount of power provided to the one or more customers loads of the at least one microgrid; or for the transition from islanded to grid-tied: responsive to determining by the plant that the sensed frequency, the sensed voltage, and the sensed phase angle on both sides of the at least one islanding breaker are not within the predetermined tolerance, performing at least one action so that the sensed frequency, the sensed voltage, and the sensed phase angle on both sides of the at least one islanding breaker are within the predetermined tolerance; and after determining whether to perform the one or more actions and perform the one or more actions, cause the at least one islanding breaker to change its state thereby transitioning the plant between grid-tied and islanded.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1 is an illustration of transitions between modes of operation.

FIG. 2A is a first schematic of a plant and a section of the grid.

FIG. 2B is a second schematic of a plant and a section of the grid.

FIG. 3A is a flow diagram illustrating transitioning from grid-tied to islanded.

FIG. 3B is a flow diagram illustrating transitioning from islanded to grid-tied.

FIG. 4A is a schematic layout of the grid and the plant operating as grid-tied.

FIG. 4B is a schematic layout of the grid and the plant operating as islanded.

FIG. 5A-B is a sequence diagram illustrating transitioning from grid-tied to islanded.

FIG. 6A-C is a sequence diagram illustrating transitioning from islanded to grid-tied.

FIG. 7 is a diagram of an exemplary computer system that may be utilized to implement the methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, the plant may operate a microgrid as grid-tied, with the microgrid being electrically connected to the grid. In practice, the plant may have an agreement with a utility that manages the grid. As one example, the plant may be contracted to dispatch renewable power to the utility responsive to the utility dispatching commands requesting renewable power. As another example, the contract may further include the capability to island with loads (e.g., the plant is configured to island with its microgrid customer loads). In this regard, the plant may be contracted to provide frequency and/or voltage regulation services while connected to the grid.

In one or some embodiments, the plant may be configured to operate in any one, any combination, or all of the following four modes of operation: grid-tied, islanded (e.g., with a microgrid); shutdown; and dormant (e.g., de-energized). In this regard, the plant may operate in any one, any combination, or all of the following different modes of operation: grid-tied; islanded; shutdown; or dormant. As discussed above, a grid-tied microgrid may operate connected to and synchronous with the power grid. An islanded microgrid may be electrically disconnected from the power grid and may function autonomously from the power grid with loads connected in circuit. Shutdown may comprise the plant ceasing to generate power. For example, the plant may be placed in the shutdown state for system wide maintenance or due to a grid outage. The microgrid customer loads may continue to be powered by the grid while the plant is in temporary shutdown if the grid is online. Shutdown may be manually triggered by the plant operator or automatically triggered responsive to electrical fault protection. Dormant may comprise the plant being de-energized.

Transitions from grid-tied to islanded and vice-versa may cause problems. As one example, transitions from a grid-tied to an islanded mode of operation may involve a momentary loss of power to customer loads (e.g., prior to resuming power from backup generators). In this regard, the customer loads may experience an interruption in power so that the transition from a grid-tied to an islanded mode is not seamless. Further, such a transition may require backup generators that are non-renewable resources to provide the power to the customer loads. In certain instances, customer loads may be large, such as at least 1 MW, which results in a large carbon footprint.

As another example, system operations and subsequent microgrid transitions for utility-scale grid connected generation assets may involve operator intervention and a significant number of manual actions. More particularly, typical transition times from grid-tied to an islanded mode of operation for utility scale generation assets is in the minutes timescale due to manual operator actions required. As discussed in more detail below, in one or some embodiments, a method and system are disclosed for a coordinated sequence of control checks and control actions that is automated with no (or minimal) operator action. Further, automated (or nearly automated) transition of a renewable system (e.g., PV solar and battery energy storage system) from grid-tied to an islanded mode may be performed in milliseconds (e.g., less than 1 minute; less than 10 seconds; less than 5 seconds; less than 1 second; less than 0.5 seconds; less than 0.1 seconds; etc.) due to its pre-programmed automated features coordinating various controller devices.

As another example, the difficulty in transitioning between modes may limit customer flexibility to reduce high energy price charges in time-of-use markets during peak price events. As discussed in more detail below, various triggers may be pre-programmed in a control system architecture (on the plant side and/or on the grid side) in order to automatically transition between any two different modes (e.g., from grid-tied to islanded). In particular, a customer supervisory control and data acquisition (SCADA) network may be preprogrammed to automatically trigger and execute the sequence to transition, thereby requiring minimal customer action when there is a desire to disconnect the facility loads from the grid, while solely receiving power from lower-priced carbon free energy. As discussed in more detail below, SCADA is an example of a control system architecture comprising computers, networked data communications and graphical user interfaces for high-level supervision of machines and processes, such as related to monitoring and/or controlling the grid and/or the microgrid.

As still another example, utility operators may have limited options during adverse grid conditions when there is an imbalance between supply and demand. As discussed in more detail below, the disclosed system and method may provide flexibility to system operators to isolate sections of the grid with critical facilities, with the end-user loads continuing to receive power from the renewable assets (e.g., PV and energy storage assets) with minimal operator action and no interruption in power.

As yet another example, most microgrid control algorithms may exist in the back-end of a controller's software and may not be accessible. The disclosed method and system of events may detail the back-end control checks and control actions that may be applied to industry available controllers and communication devices that may be customizable at least in part.

Thus, in one or some embodiments, the system may comprise one or both of control hardware and power devices (e.g., breakers, switches, relays, etc.) on one or both of the plant side or the grid side that may be configured to transition (such as at least party automatically transition or fully automatically transition) between any one, any combination, or all of the different modes of operation of the plant discussed above. Similarly, a method is disclosed that transitions (such as at least party automatic transitions or fully automatically transitions) between any one, any combination, or all of the different modes of operation of the plant discussed above. In particular, the system may be configured to perform a sequence of events that describes a series of control checks and/or actions performed by one or more devices resident in one or both of the plant or the grid. The one or more devices may comprise any one, any combination, or all of: controllers (e.g., or other types of computational or logical functionality); switches; circuit breakers; power control systems (PCSs); inverters; relays; communication devices; or other equipment within the plant (e.g., within a microgrid-equipped powerplant) or within the grid (e.g., within a substation of the grid).

In one or some embodiments, the system and method disclose a plant transitioning from a grid-tied mode to an islanded mode. Alternatively, or in addition, the system and method disclose transitioning the plant from an islanded mode to a grid-tied mode. The transitions may prevent loss of power to customer loads connected in circuit with the plant microgrid. As discussed above, the plant may include a microgrid with one or more customer loads. The system and method may provide a seamless transition (e.g., no loss of power or disruption of power and/or no reliance on an external power source (such as generator(s))) for the one or more customer loads when transitioning from the grid-tied mode to the islanded mode and/or vice-versa. As discussed herein, there may be various reasons for initiating the transition from grid-tied to islanded, including grid-side triggers (e.g., instability of the grid such as grid outages, power quality issues, or rolling blackouts) and/or plant-side or customer triggers (e.g., avoiding cyberattacks or the like). Likewise, there may be various reasons for initiating the transition from islanded to grid-tied, including the plant reconnecting to the grid to resume grid dispatch or to provide the customer loads a longer-term stable power supply. In this regard, in one or some embodiments, the system and method may transition while preventing loss of power to customer loads (e.g., customer loads that are provided at least 1 MW), while reducing the potential for operator error(s) during the transitions through a detailed automation implementation, as described in more detail below. Furthermore, the sequence of events described in the transitions may provide flexibility to system operators and regulators during various events (such as during adverse grid events) that may result in power outages to rate payers. Further, end user customer flexibility may be improved by providing the ability to disconnect from the grid while still receiving power from the plant (e.g., local renewable generation and storage assets resident in the plant), thereby mitigating power quality issues, high pricing in time-of-use rate markets, and a seamless back up power supply from clean renewable generation/storage.

In this regard, in one or some embodiments, a method and system are disclosed to transition the plant between grid-tied and islanded (e.g., grid-tied to islanded and/or islanded to grid-tied). The plant includes at least one microgrid that supplies power to one or more customer loads, with the plant when grid-tied providing or receiving power to at least a part of a grid that is operated by a utility and with the plant when islanded being disconnected from providing or receiving power to the at least a part of the grid. The method includes: responsive to an indication to transition the plant between grid-tied and islanded (e.g., the indication may comprise a command that is generated by the utility and then transmitted to the plant and/or the indication is generated by the plant itself), performing one or more checks prior to the transition. The one or more checks may comprise: for the transition from grid-tied to islanded: determining an amount of power provided to the grid (e.g., the amount of power currently provided to the grid) and an amount of power provided to the one or more customers of the plant (e.g., the amount of power currently provided to the one or more customers); or for the transition from islanded to grid-tied: determining, by the plant, whether sensed frequency (e.g., frequency sensed in real time by at least one sensor), sensed voltage (e.g., voltage sensed in real time by at least one sensor), and sensed phase angle (e.g., phase angle sensed in real time by at least one sensor) on both sides of the at least one islanding breaker is within a predetermined tolerance (e.g., the difference of the frequency on both sides of the at least one islanding breaker is within a predetermined frequency difference tolerance; the difference of the voltage on both sides of the at least one islanding breaker is within a predetermined voltage difference tolerance, and the difference of the phase angle on both sides of the at least one islanding breaker is within a predetermined frequency phase angle tolerance). Further, responsive to performing the one or more checks prior to the transition, the plant may determine whether to perform one or more actions, such as: for the transition from grid-tied to islanded: responsive to determining the amount of power provided to the grid and the amount of power provided to the one or more customers of the plant, modifying power output of the plant to be the amount of power provided to the one or more customers loads of the at least one microgrid; or for the transition from islanded to grid-tied: responsive to determining by the plant that the sensed frequency, the sensed voltage, and the sensed phase angle on both sides of the at least one islanding breaker are not within the predetermined tolerance, performing at least one action so that the sensed frequency, the sensed voltage, and the sensed phase angle on both sides of the at least one islanding breaker are within the predetermined tolerance. After determining whether to perform the one or more actions and performing the one or more actions, the islanding breaker is caused to change its state thereby transitioning the plant between grid-tied and islanded (e.g., the plant may send an indication to the utility that the plant is ready to be islanded and/or to be grid-tied and then for the utility to then command the islanding breaker; the plant may send a command to control the islanding breaker).

Thus, the disclosed system and method may improve the robustness and flexibility of utility-coordinated renewable generation microgrid assets, including any one, any combination, or all of: (1) ensuring uninterruptable or seamless power to microgrid customer(s) during planned grid outages; (2) reducing manual utility or power plant operator action(s) through an automated coordination of controller devices thereby decreasing the potential for human error during power plant system transitions; (3) providing flexibility to utility system operators and regulators to keep power online in critical load zones through coordinated disconnection procedures during rolling blackout events triggered by imbalance between utility supply and demand; (4) providing flexibility to end-load customers with the ability to disconnect from the utility grid and maintain power from renewable assets during events of high energy pricing; (5) improving power quality to customer loads by facilitating a planned seamless disconnection from a diverse utility grid system and receive power from solely renewable resources (e.g., a 100% carbon free energy solution consisting of photovoltaic solar and energy storage to power the microgrid); (6) reducing the potential for cyber-attacks resulting in loss of utility power to critical facilities by isolating the critical facility loads from the utility grid, while receiving power from the local PV and Energy storage microgrid; and (7) providing predetermined frequency and voltage control within tolerable or predefined bounds during transition from grid-tied to islanded mode of operation and vice-versa.

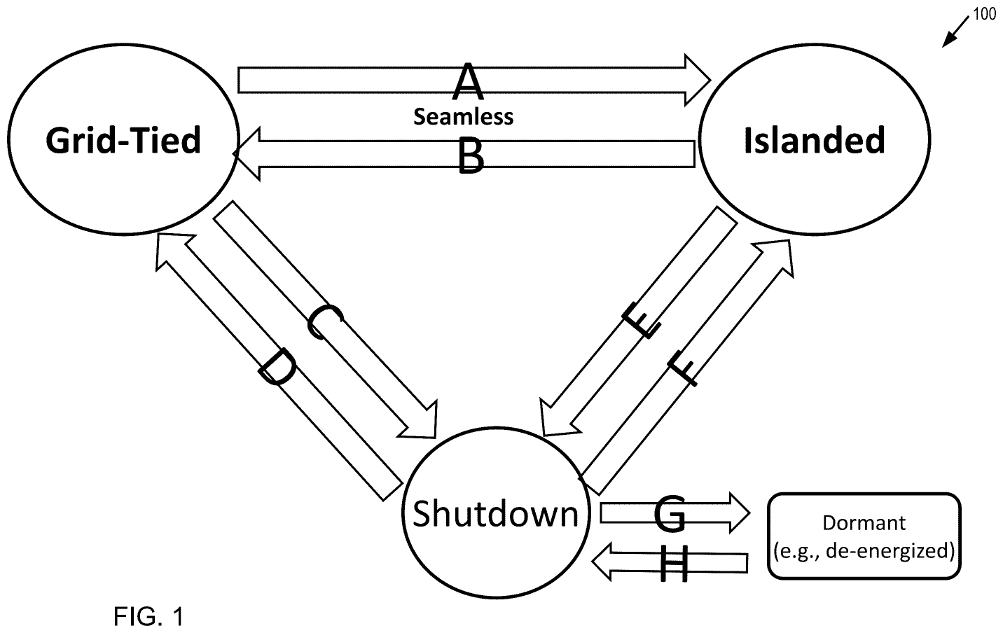

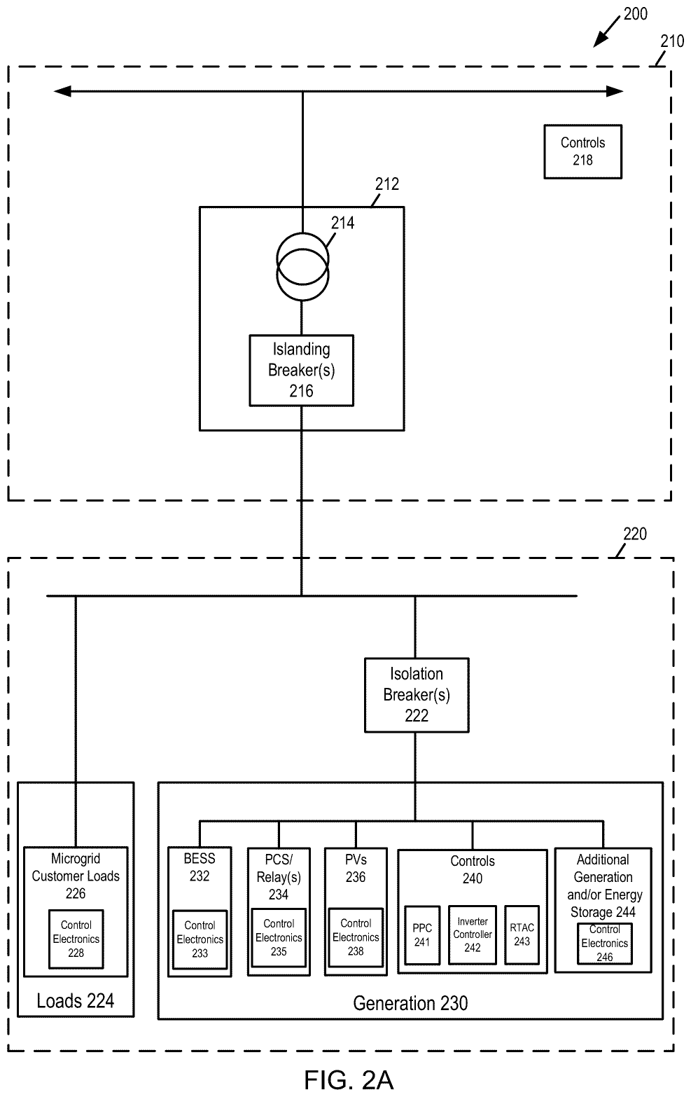

Referring to the figures, FIG. 1 is an illustration 100 of transitions between modes of operation. FIG. 1 illustrates four modes of operation including grid-tied, islanded, shutdown, and dormant. In one or some embodiments, any one, any combination, or all four of the modes of operation listed may be used in managing the plant. Alternatively, fewer or greater numbers of modes may be used in managing the plant.

In one or some embodiments, grid-tied comprises the plant being electrically connected to the grid, and thus having the capability to provide power to and/or receive power from the grid. In one or some embodiments, islanded comprises the plant being operational (e.g., being configured to provide power, either via generation and/or by dispensing previously stored power, to a microgrid) but being electrically disconnected from the grid, and thus being incapable of providing power to and/or receiving power from the grid. In one or some embodiments, shutdown comprises the plant not being operational (e.g., being unable to provide power). In one or some embodiments, dormant comprises that the plant is de-energized. As shown in FIG. 1, there are eight potential transitions in modes including: (A) grid-tied to islanded; (B) islanded to grid-tied; (C) grid-tied to shutdown; (D) shutdown to grid-tied; (E) islanded to shutdown; (F) shutdown to islanded; (G) shutdown to dormant; and (H) dormant to shutdown.

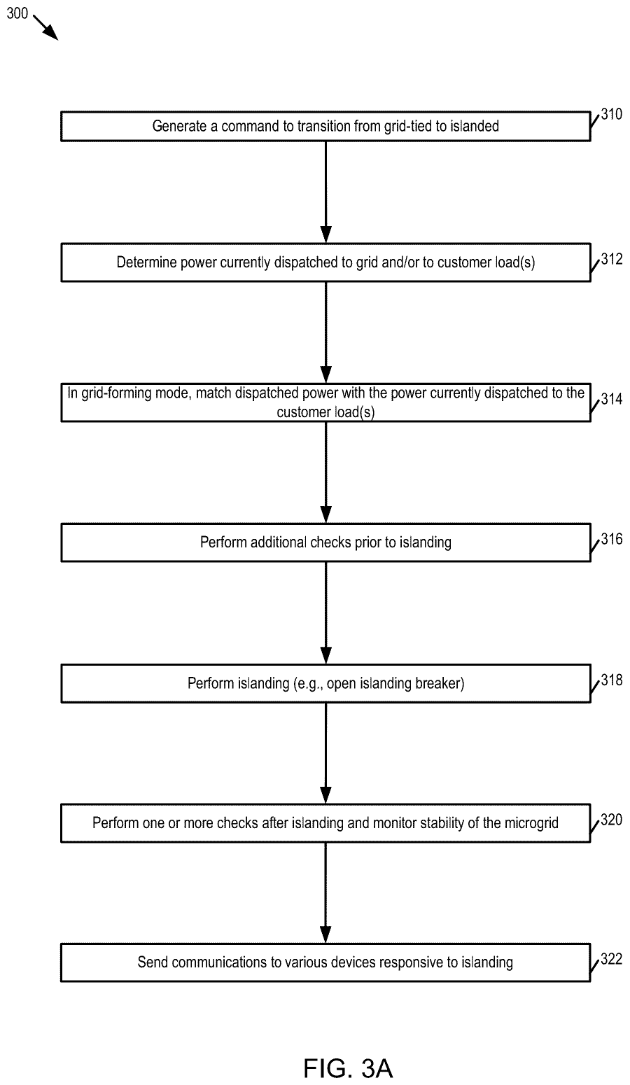

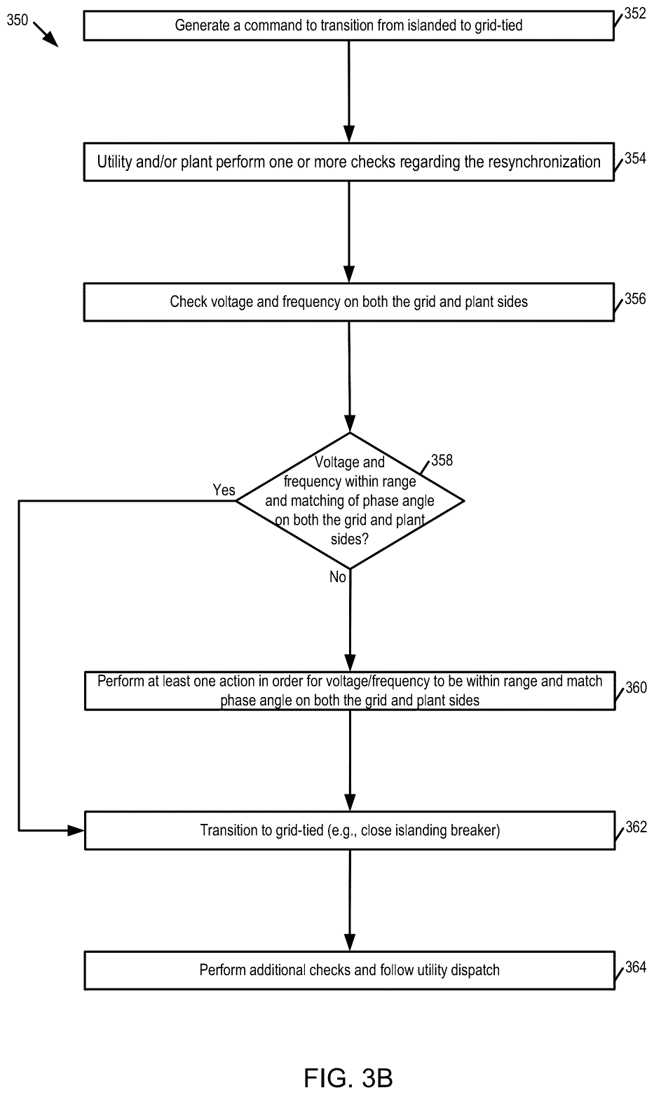

Transitions (A) and (B) are explained in more detail below with a description of the initial status of the hardware (e.g., the circuit breakers and/or disconnect switches) followed by the steps to successfully transition to the desired mode of operation. Each of Transitions (A) and (B) may involve a series of control checks and subsequent control actions taken, such as discussed with regard to FIGS. 3A-B, 4A-B, 5A-B, and 6A-C.

In one or some embodiments, a “step” may include one or more verifications and decisions that may lead to one or more actions. A “control check” may comprise logic that holds or confirms a condition before executing an action. A “control action” may comprise a command from a controller (or other computational functionality) to equipment(s). Example control actions comprise any one, any combination, or all of: closing a switch; opening a breaker; adjusting set point; etc. Other control actions are contemplated.

As discussed further below, various electronic devices, such as controllers and/or hardware, may communicate with one another, such as via wired and/or wireless communication. Various communication protocols are contemplated. As one example, Modbus may be used to communicate amongst the various electronic devices. Alternatively, IEC 61850, GOOSE, or other communication protocols are contemplated.

Various types of transitions are contemplated. In one embodiment, the transition is “planned”, which may mean that the transition is initiated by an operator (either an operator of the utility that manages the grid or an operator of the plant that manages the plant). Unplanned transitions are events that may occur without foresight (e.g., protection equipment tripping on an electrical fault or equipment failure).

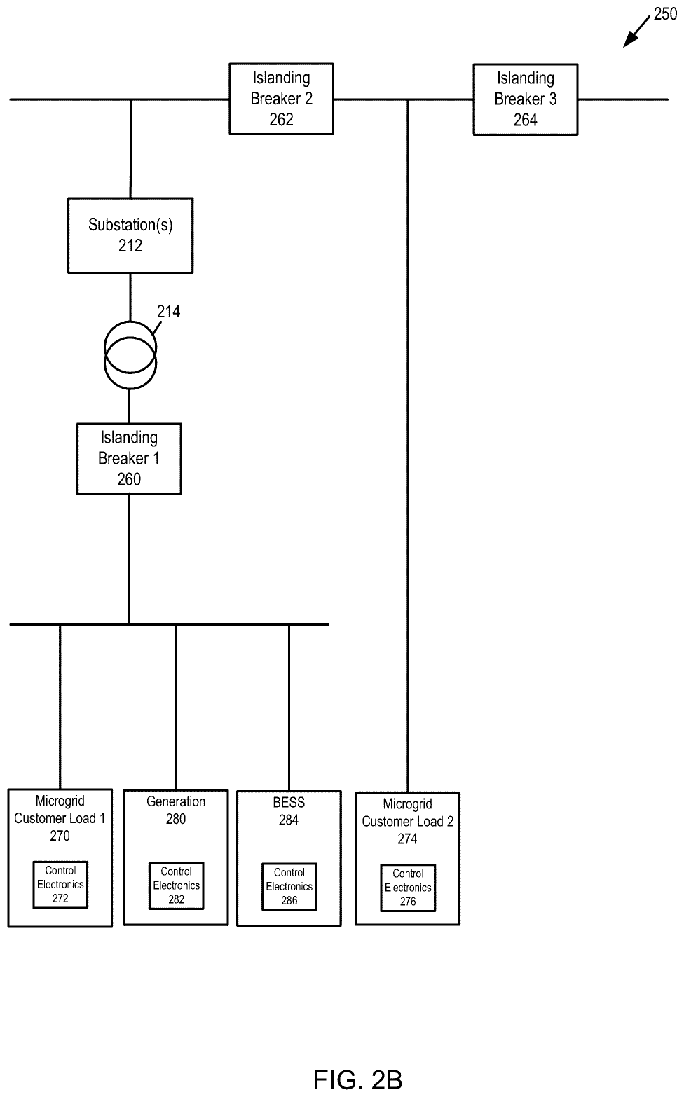

FIG. 2A is a first schematic 200 of a plant 220 and a section of the grid 210 in which the generation is co-located with the microgrid customer load(s), thereby enabling a single disconnection point (e.g., at islanding breaker(s) 216). Grid 210 may comprise a traditional wide area synchronous grid (alternatively termed a macrogrid). Other types of grids are contemplated. In one or some embodiments, the grid 210 may comprise any one, any combination, or all of: generation (e.g., electricity produced by using fossil fuels, nuclear material, or renewable energy resources); transmission (e.g., long-distance power lines carrying electricity at high voltages); and distribution (e.g., substations that convert electricity to lower voltages; thereafter, distribution lines carry the lower voltages to homes and businesses). For example, grid 210 may comprise a three-phase electric power grid that has regional scale or greater and that operates at a synchronized utility frequency and voltage, and is electrically tied together during normal system conditions. Electricity may be transmitted across long distances using high-voltage transmission lines, with local facilities, such as substation(s) 212, converting the high-voltage power to a lower voltage (e.g., stepping down the voltage) in order to distribute the power to nearby homes or businesses. Various step downs in voltage are contemplated. Merely by way of example, the transformer may step down from 57 kV to 12.5 kV. Substation(s) 212 may include various electronics, such as relays, transformers (e.g., generator step-down transformers (GSU)) to change voltage levels between high transmission voltages and lower distribution voltages, or at the interconnection of two different transmission voltages. Substation(s) 212 may further include relays, breakers, or the like. For example, FIG. 2A illustrates that substation(s) 212 may include islanding breaker(s) 216, which may be electrically connected via various electronics, such as transformer 214. FIG. 2A further illustrates controls 218, which may comprise computing functionality configured to control one or more parts of the grid 210. An example of controls 218 comprises utility real-time automation controller (RTAC) 510, discussed further below.

Various controls are contemplated for plant 220. As one example, higher level control may be manifested in controls 240, which may include any one, any combination, or all of a power plant controller (PPC) 241, inverter controller(s) 242 or RTAC 243. Lower level control may be manifested in various parts of the plant 220, such as power conversion system (PCS) controller(s) and/or relay(s) 234. SCADA may further be included within plant 220. See control electronics 228, 233, 235, 238, 246.

As shown, the plant 220 includes generation 230 and may service one or more loads 224. Generation 230 generally may be configured to provide power, such as by one or both of generating power or providing power previously stored. Various types of generation are contemplated, including any one, any combination, or all of solar, wind, hydroelectric, or the like. As shown in FIG. 2A, photovoltaics (PVs) 236 may be used for generation 230. In one or some embodiments, only one type of generation (e.g., solar) is used. Alternatively, multiple types of generation and/or energy storage may be used, such as illustrated by additional generation and/or energy storage 244. Similarly, various types of storage of power for later use are contemplated. As one example, batteries, such as in form of Battery Energy Storage Solutions (BESS) 232 are contemplated. As another example, pumped-storage hydroelectricity (alternatively termed pumped hydroelectric energy storage) is contemplated. FIG. 2A further illustrates controls 240, which may comprise central controlling functionality configured to control plant 220. Alternatively, or in addition, the controlling functionality configured for the plant 220 may be decentralized. In this regard, different types of solar and battery systems, power conversion systems, and other variations of balance of plant equipment are contemplated.

Plant 220 may further include one or more loads 224. One example of a load is a microgrid customer load 226. In one or some embodiments, a microgrid comprises a localized electrical grid with device boundaries that may act as a single and controllable entity under control of controls 240. In particular, in one or some embodiments, the microgrid may comprise energy generation and/or energy storage, and may power one or more loads. Various loads are contemplated. As one example, the plant 220 may power a defined area, such as a building. In particular, the plant 220 may power electrical machinery, computers, lighting, or other types of electronic devices. As another example, the plant 220 may power a separate system, such as hydrogen electrolyzers, data centers, or the like.

In practice, plant 220 may distribute power to one or both of the grid 210 or the loads 224. When supplying power to the grid 210, the plant is grid-tied. There may be certain instances where the plant is to be islanded. Various instances are contemplated. In one instance, the plant 220 may be islanded based on operations in the grid 210, such as instability of the grid. As one example, the grid 210 may be unstable, leading to sections of the grid being subject to rolling blackouts. In one or some embodiments, a rolling blackout may comprise an intentionally engineered electrical power shutdown in which electricity delivery is stopped for non-overlapping periods of time over different parts of the grid. A rolling blackout may comprise a planned event as a last resort measure used by a utility company in order to avoid a total blackout of the grid. In another instance, the plant 220 may be islanded based on operations within the plant 220 (e.g., within the load 224). For example, the load 224, such as microgrid customer loads 226, may seek to island from the grid 210 to avoid cyberattacks or the like.

Thus, in one implementation, the microgrid may be electrically connected to the grid 210 (e.g., grid-tied). Alternatively, the microgrid may be electrically disconnected from the grid 210, such as an islanded microgrid or an isolated microgrid. Islanding breaker(s) 216 may achieve the islanding. For example, responsive to a command (which may originate from the grid 210 (e.g., controls 218) and/or from the plant 220 (e.g., controls 240), the islanding breaker(s) 216 may change its state in order to electrically separate the plant 220 from the grid 210. In this regard, in one or some embodiments, the islanding breaker(s) 216 may comprise electronics, such as circuit breaker(s) that electrically separate the grid from one or both of the microgrid loads (e.g., loads 224) and the generating plant (e.g., generation 230).

Separate from islanding plant 220, loads 224 may be electrically separated, such as by isolation breaker(s) 222. For example, responsive to controls 240 commanding isolation breaker(s) 222 to electrically disconnect the electrical connection to loads 224, isolation breaker(s) 222 may electrically open. In one or some embodiments, isolation breakers may comprise electronics, such as circuit breaker(s), that separate generation 230 from the loads 224 (e.g., the microgrid customer loads 226).

As shown in FIG. 2A, control electronics may be present in various parts of the grid 210 or the plant 220. For example, grid 210 includes controls 218, which may comprise centralized and/or decentralized controls. Plant 220 includes control electronics 233, 235, 238 246 within generation 230 and control electronics 228 within loads 224. Further, plant 220 may include controls 240. As discussed in more detail below, plant 220 may include plant RTAC 512, plant PPC 514, and plant power conversion system (PCS) controller 516. These elements may be included in any one of the control electronics as shown in plant 220 in FIG. 2A.

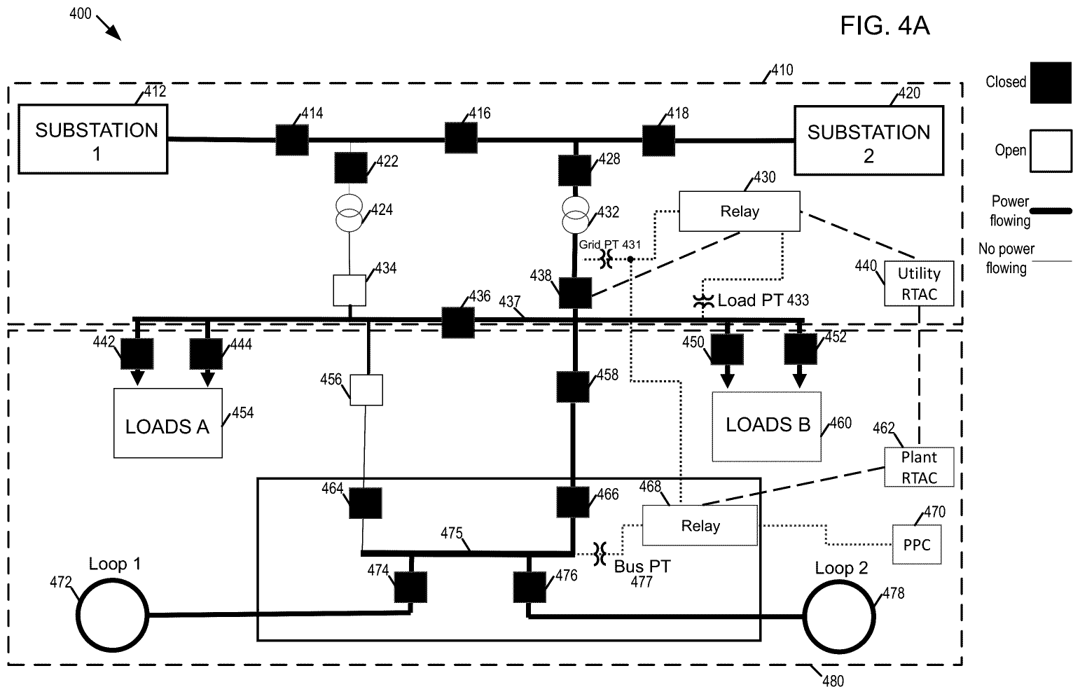

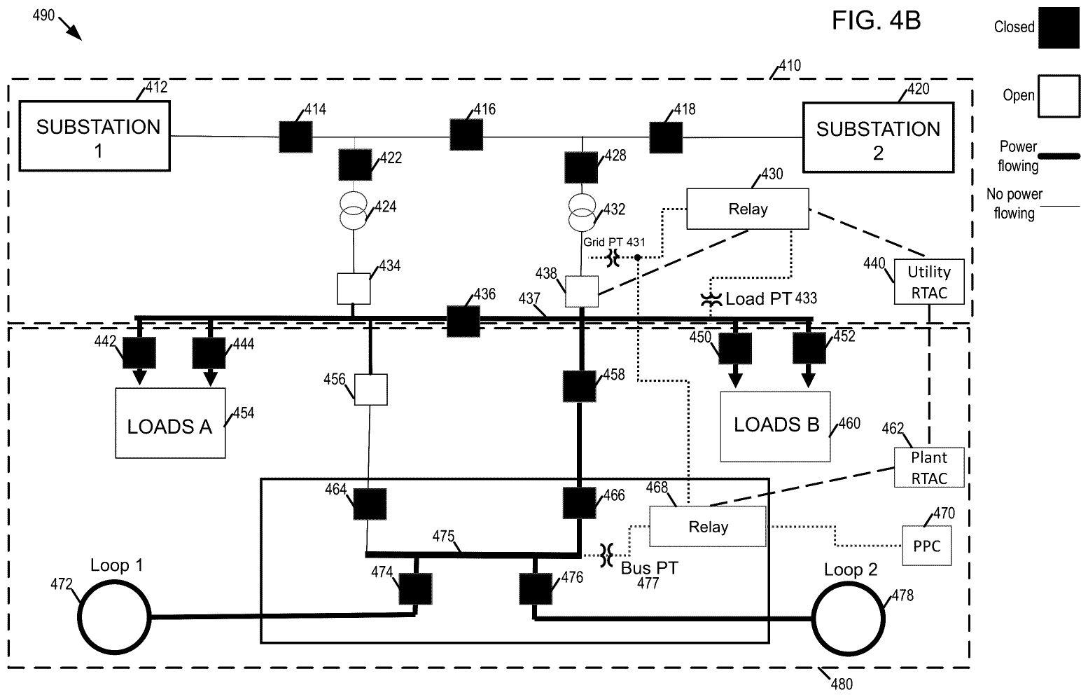

The devices depicted in FIGS. 4A-B, 5A-B and 6A-C may reside in various places. For example, the plant RTAC 512 may comprise its own separate controls device (e.g., separate from the plant PPC 514 or the plant PCS controller 516). In one or some embodiments, the plant RTAC 512 may include a communication interface in order to communicate with one or more electronic devices for the utility (e.g., a utility RTAC 510). In this regard, the plant RTAC 512 may comprise a utility interface controller and/or a real time automation controller. Further, in one or some embodiments, plant PPC 514 and plant PCS controller(s) 516 may be separated into discrete electronic devices. For example, the plant PCS controller(s) 516 may be located within the PCSs as it may be seen as the lowest form of control.

Therefore, in instances where the plant 220 is islanded from the grid 210, various parts of the plant, such as one or both of part of or all of the generation 230 or part of or all of the loads 224 may be powered. In this way, the microgrid customer loads 226 may still be powered even when the plant 220 is islanded from the grid 210. Further, as discussed in more detail below, the transition from grid-tied to islanded and/or the transition from islanded to grid-tied may be seamless insofar as the microgrid customer loads need not see any interruption or disruption in the power supplied.

In this regard, in one or some embodiments, a microgrid sequence of events (SOE) methodology is disclosed for DC-coupled utility-scale Solar Photovoltaic (PV) and Energy Storage systems (e.g., BESS) to transition between grid-tied and islanded modes of operation with no interruption in power to customer loads (e.g., seamless transitions). The SOE disclosed herein may coordinate a PV and Energy storage power plant controller (PPC), an example of controls 240, with lower-level power conversion system (PCS) controllers, protection relays, and communication interfaces with the utility to enable the automated transitions between the different modes. As described in more detail with regard to FIGS. 3A-B, 4A-B, 5A-B, and 6A-C, the pre-programming of the sequence control checks and control actions into the various controller and communication devices may ensure minimum utility, power plant operator, or customer involvement during automated microgrid transition events.

FIG. 2B is a second schematic 250 of a plant and a section of the grid, with scattered load with different disconnection points, thereby necessitating three islanding breakers (islanding breaker 1 (260), islanding breaker 2 (262), and islanding breaker 3 (264)). As shown, generation 280, BESS 284, and microgrid customer load 1 (270) connect to a first part of the grid and microgrid customer load 2 (274) connect to a second part of the grid. As such, the respective islanding breakers may island the different sections of the microgrid. Further, FIG. 2B illustrates control electronics 272, 276, 282, 286 which may be configured to control operations, as discussed further below.

FIG. 3A is a flow diagram 300 illustrating transitioning from grid-tied to islanded. At 310, a command is generated to transition from grid-tied to islanded. In one embodiment, the utility may generate the command, such as due to grid instability, rolling blackouts, or the like. For example, in a planned grid-tied to islanded event, the utility may issue a command to the plant to begin the transition into islanded mode. Alternatively, or in addition, the plant may generate the command, such as due to sensed instability in the grid or due to seeking to island the customer loads to prevent cyber-attacks or the like. Responsive to the command, at 312, power dispatched to the grid and/or power to the customer load(s) is determined (e.g., the amount of power that is currently being provided to the grid and/or the amount of power currently provided to the customer load(s)). At 314, in grid-forming mode, the plant may match the dispatched power with the power currently dispatched to the customer load(s). For example, the plant may receive the microgrid customer real power and the reactive power consumption values and may adjust the plant dispatch accordingly (e.g., so that the plant dispatch is within a predetermined tolerance of the microgrid customer real power and the reactive power consumption). As discussed in more detail below, various electronics, such as PCSs and/or inverters on the plant side, may be controlled in order to adjust the plant dispatch. In one or some embodiments, this adjustment is performed prior to opening the islanding breaker(s) (e.g., in real-time or near real-time prior to opening the islanding breaker(s), such as within a predetermined number of microseconds prior to opening the islanding breaker(s)). At 316, prior to islanding, one or more additional checks may be performed. The one or more additional checks may be performed on one or both of the utility side (e.g., sensing one or more aspects in the grid) or on the plant side (e.g., sensing one or more aspects in the microgrid). For example, the islanding breaker (which may be positioned in the grid) may determine whether one or both of the frequency or the voltage are within a certain tolerance. In this regard, additional checking may be performed in order to ensure that after islanding, the microgrid and/or the section of the grid is not negatively affected by the islanding.

At 318, islanding is performed, such as by opening the islanding breaker(s). In the event that the islanding breaker(s) is positioned in the grid (and controlled by the utility), a controller resident in the grid and controlled by the grid (e.g., an operator of the utility) may command the islanding breaker to open. Alternatively, in the event that the islanding breaker is positioned in the plant (and controlled by the plant), a controller resident in the plant may command the islanding breaker to open. After islanding, the microgrid customer loads may be powered by the plant and may be isolated from the grid.

After islanding, at 320, one or more checks may be performed and the microgrid may be monitored for stability. At 322, one or more communications may be sent to various devices (e.g., devices on the utility side) responsive to the islanding, such as updating the status of the islanding breaker and/or of the mode of operation. Alternatively, or in addition, a hard-wired contact from the islanding breaker to the power plant controller may be included in order to allow the power plant controller to know instantaneously when the islanding breaker is opened (one or more wires, not shown in FIGS. 4A-B, may communicatively connect the islanding breaker to the power plant controller). In this way, the power plant controller may control the power distribution between the various PCSs quicker, and allow for a smoother transition.

FIG. 3B is a flow diagram 350 illustrating transitioning from islanded to grid-tied. At 352, a command is generated to transition from islanded to grid-tied. In one embodiment, the utility may generate the command. Alternatively, or in addition, the plant may generate the command. For example, the planned transition from islanded to grid-tied mode may be performed after the conclusion of a grid outage event. After which, the plant may resume its normal default operation by providing grid-support services in grid-tied mode, while simultaneously powering the microgrid customer loads.

At 354, the utility and/or the plant perform one or more checks regarding the resynchronization. As one example, the plant may determine a current status of the plant and/or of the islanding breaker (e.g., that the islanding breaker is open). As another example, an electronic device, such as a generator protection relay, may utilize an auto-synchronization function to mitigate a difference in frequency and/or voltage on either side of the islanding breaker during the reconnection process. As still another example, the power plant controller may check the breaker configuration(s) to ensure it is in an islanded mode of operation.

In one or some embodiments, this may be achieved through corrective pulse width modulation (PWM) signals sent to the plant's power plant controller (PPC) from the generator protection relay. In particular, the power plant controller may adjust the microgrid frequency and voltage to match the grid side frequency and voltage within a predefined tolerance. Simultaneously (such as at least partly simultaneously) or within a predetermined time interval, a relay that performs the synchronization check function over the islanding breaker(s) may perform its synchronization check function to verify the real-time frequency and voltage on either side of the islanding breaker are within the predefined tolerance. Once in range, the relay performing the synchronization check function may close the islanding breaker(s) to reconnect the microgrid back to grid. In one or some embodiments, the auto-synchronization function may provide a kick pulse to assist in matching the voltage phase angle of the microgrid to the voltage phase angle of the grid.

At 356, the voltage and frequency may be checked on both the grid and plant sides. At 358, the voltage and frequency may be checked to be within range on both the grid and plant sides and checked for phase angle match on both the grid and plant sides. In particular, after transitioning back to grid-tied, the plant and/or the grid should not be subject to disruptions, such as with regard to any one, any combination, or all of frequency, voltage, and phase angle. As such, a check (such as a final check) prior to closing the islanding breaker is to check the frequency, voltage, and the phase angle on both sides of the islanding breaker.

Responsive to determining that the voltage and frequency are within range and the phase angle is matched on both the grid and plant sides, flow diagram 350 moves to 362 in which the plant transitions back to grid-tied (e.g., by closing the islanding breaker). If not, at 360, at least one action is performed in order for the voltage and frequency to be within range and the phase angle to match on both the grid and plant sides. Various actions are contemplated. In one or some embodiments, the action may comprise a device on the plant side performing the action. As one example, the plant PPC 470 may be configured to modify operation of the microgrid, such as changing the voltage and/or frequency setpoints for the microgrid. In practice, the plant PPC 470 may send a command to one or more power conversion systems and/or inverters in order to modify the voltage and/or frequency setpoints for the microgrid. Alternatively, or in addition, the action may comprise waiting a predetermined time, after which the voltage and/or frequency on both the grid and plant sides may be checked again. In this regard, the action performed may be active or passive. In either instance, after the at least one action is performed, the transition to grid-tied may be performed at 362. After which, at 364, additional checks may be performed (e.g., to ensure stability of the plant) and the plant may follow utility dispatch.

FIG. 4A is a schematic layout 400 of the grid 410 and the plant 480 operating as grid-tied showing the breakers/switches with breakers/switches 414, 416, 418, 422, 428, 436, 438, 442, 444, 450, 452, 456, 458, 464, 466, 474, 476 closed/energized and with breakers/switches 434, 458 open/de-energized showing where power is flowing and where no power is flowing (see key in FIGS. 4A-B). Grid may include one or more substations, such as substation 1 (412) and substation 2 (420), and various control electronics, such as transformers (see transformer 424, transformer 432, grid PT 431, load PT 433, and bus PT 477), relay 430 and utility RTAC 440. In one or some embodiments, relay 430 is configured to perform the synchronization check to ensure the microgrid frequency, voltage, and phase angle is within the predetermined tolerance to the frequency, voltage and phase angle of the grid. In particular, in one or some embodiments, relay 430 may include one or more sensors configured to sense (such as sense in real time) any one, any combination, or all of: the microgrid frequency, voltage, or phase angle. In this regard, in one or some embodiments, the one or more sensors in relay 430 may comprise separate frequency sensor(s) configured to sense the microgrid frequency, voltage sensor(s) configured to sense the voltage, and phase angle sensor(s) configured to sense the phase angle.

Plant 480 includes one or more loops, such as loop 1 (472) and loop 2 (478), which may comprise energy sources (e.g., generation and storage), such as PVs, BESS or the like. Loop 1 (472) and loop 2 (478) may be connected to switchgear 475. Plant 480 further includes one or more microgrid customer loads, such as loads A (454) and loads B (460), and various control electronics, such as circuit breaker 466, plant RTAC 462, and plant power plant controller (PPC) 470.

As shown, islanding breaker 438 may be electrically connected to substation bus 437. Further, as shown islanding breaker 438 is closed, meaning that the plant 480 is grid-tied. Therefore, power flows from loop 1 (472) and loop 2 (478) to loads A (454) and loads B (460), and flows between grid 410 and plant 480.

FIG. 4B is a schematic layout 490 of the grid 410 and the plant 480 operating as islanded. Specifically, FIG. 4B illustrates the plant 480 and microgrid customer loads (loads A (454) and loads B (460)) as being islanded, with the breaker positions within the islanded mode of operation (see islanding breaker 438 is open, thereby islanding plant 480 from grid 410).

As discussed in more detail below, relay 468 may be configured to perform one or both of: (1) the synchronization check function to determine difference(s) in frequency and/or voltage on either side of the islanding breaker; and (2) auto-synchronization to reduce or mitigate the difference in frequency and/or voltage on either side of the islanding breaker (e.g., 438), such as through corrective PWM signals sent to the plant PPC 470 from relay 468. Further, relay 430, positioned in the grid, may likewise perform the synchronization check function over the islanding breakers. In one or some embodiments, relay 430 may further be configured to perform auto-synchronization to reduce or mitigate the difference in frequency and/or voltage on either side of the islanding breaker.

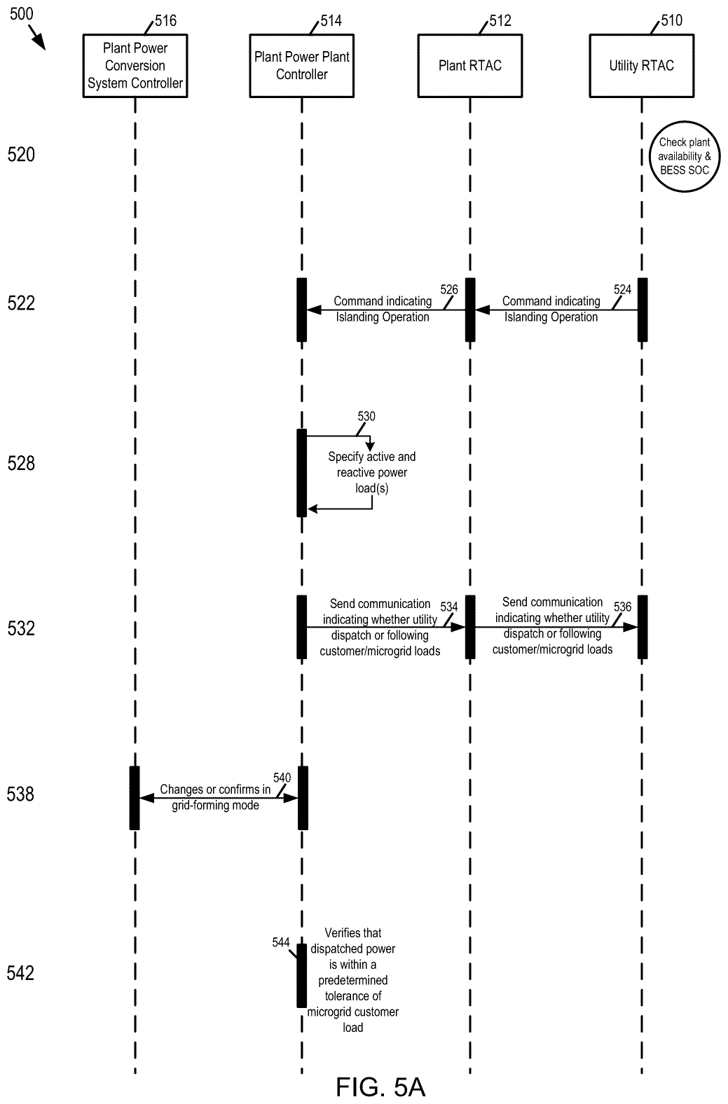

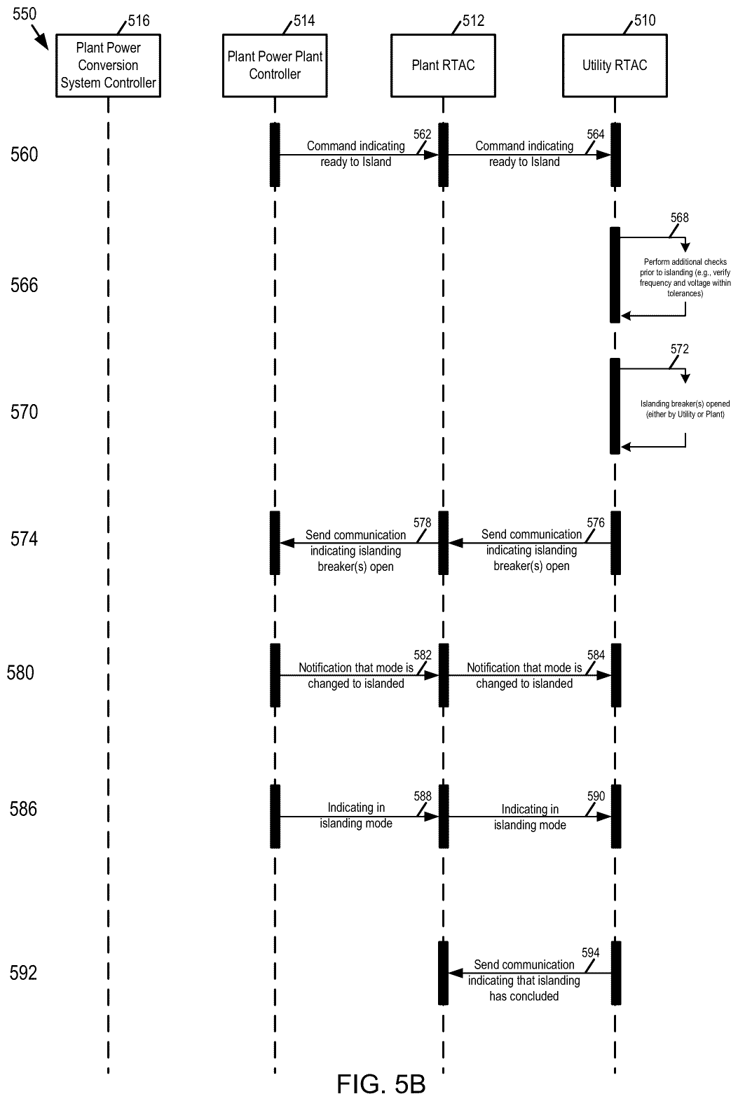

FIG. 5A-B is a sequence diagram 500, 550 illustrating transitioning from grid-tied to islanded, including actions and/or communications between the utility RTAC 510, the plant RTAC 512, the plant PPC 514, and the plant PCS controller 516. At 520, the utility RTAC 510 checks plant availability and BESS state of charge (SOC). In particular, in preparation for islanding, the utility (such as utility RTAC 510) may check whether the plant is available (e.g., not in shutdown) and whether there will be sufficient power and energy. At 522, FIG. 5A illustrates a series of communications with, at 524, the utility RTAC 510 sending a command to the plant RTAC 512 indicating an islanding operation, and in turn, with, at 526, the plant RTAC 512 sending a command to the plant PPC 514 indicating an islanding operation. In this regard, FIG. 5A illustrates an islanding event initiated by the utility. Alternatively, the plant may initiate the islanding event (e.g., the plant operator may initiate the planned islanding sequence through the SCADA human machine interface (HMI)).

At 528, the plant PPC 514 may sense at least a part of operation of the plant, such as specifying active and/or reactive power of the load(s) at 530. In particular, the plant PPC 514 may identify the initialization and may read active and reactive power load consumption over one or more feeders summed through (e.g., the sum of active power load values being read from all of the microgrid customer's load feeder meters, such as for loads A (454) and loads B (460) in FIGS. 4A-B).

At 532, FIG. 5A illustrates a series of communications with, at 534, the plant PPC 514 sending a communication to the plant RTAC 512 indicating whether the plant is utility or microgrid load following, and in turn, with, at 536, the plant RTAC 512 sending a command to the utility RTAC 510 indicating whether the plant is utility or microgrid load following (e.g., whether utility dispatch or following customer or microgrid loads). These communications at 532 may serve as feedback to the utility as to whether the plant is successfully progressing through the transition. In this regard, the communications may allow the plant PPC 514 to trigger subsequent control check/control actions, and change plant dispatch to utility dispatch or load following function.

At 538, the plant PPC 514 changes to or confirms that the plant is in grid-forming mode (see 540, which may comprise communications from the plant PPC 514 to the plant PCS controller and/or vice versa). At 542, the plant PPC 514 may verify that the plant dispatched power is within a predetermined tolerance of the microgrid customer load (see 544) (e.g., the plant dispatched is no more than 2% of the customer load power consumption). For example, the plant may be dispatching power to both the utility and to the microgrid customer loads, such as dispatching 10 MW to the utility and dispatching 2 MW to the microgrid customer loads. With the islanding sequence, the output from the plant will drop to 2 MW (or to within predetermined tolerance of 2 MW). As another example, the plant may be contracted to perform frequency and/or voltage regulation for the grid. In this regard, if the frequency is less than 60 Hz (e.g. 59 Hz), the plant may automatically increase the active power provided to the grid to return the frequency on the grid back to 60 Hz (e.g., perform frequency regulation). In such an instance where the plant is dispatching 2 MW to the microgrid customer loads, the plant may further dispatch an amount for frequency/voltage regulation of the grid (e.g., an addition. 5 MW flowing through the islanding breaker per programmed droop settings). Prior to the switch to islanding, the plant and/or the utility may ensure that the plant is supplying sufficient power to the microgrid loads (and not to provide additional power for frequency and voltage regulation).

After which, at 560, FIG. 5B illustrates a series of communications with, at 562, the plant PPC 514 sending a communication to the plant RTAC 512 indicating readiness for islanding, and in turn, with, at 564, the plant RTAC 512 sending a command to the utility RTAC 510 indicating readiness for islanding. At 566, final checks prior to islanding occurs. Specifically, at 568, the utility RTAC 510 may verify whether the frequency and voltage are within tolerance (e.g., frequency within 0.1% of nominal; voltage 3% of nominal). If so, at 570, islanding occurs. If not, the utility RTAC 510 may wait until the frequency and voltage are within tolerance.

After which, islanding may occur. Specifically, at 572, the utility RTAC 510 commands the islanding breaker(s) to open. As shown in FIGS. 5A-B, the islanding breaker is within the utility grid. As such, the utility (such as the utility RTAC 510) may control the islanding breaker to open. Alternatively, in the event that the islanding breaker is within the control of the plant, the plant RTAC may command the islanding breaker to open.

After the islanding breaker has opened, the status of the islanding breaker being opened may be communicated within one or both of the grid or the plant. In one or some embodiments, there may be a hard-wired contact between the islanding breaker and the plant PPC 514. Sec 461 in FIGS. 4A-B. Alternatively, the status of the islanding breaker being opened may be communicated through SCADA. This is illustrated, for example, at 574, in which FIG. 5B illustrates a series of communications with, at 576, the utility RTAC 510 sending a communication to the plant RTAC 512 indicating that the islanding breaker is open, and in turn, with, at 578, the plant RTAC 512 sending a command to the plant PPC 514 indicating the islanding breaker is open. After which, at 580, FIG. 5B illustrates a series of communications notifying that the plant has changed its mode to islanded with, at 582, the plant PPC 514 sending a communication to the plant RTAC 512 indicating the current mode is islanded, and in turn, with, at 584, the plant RTAC 512 sending a command to the utility RTAC 510 indicating that the plant is in islanded mode. Further, at 586, FIG. 5B illustrates a series of communications (588, the plant PPC 514 sending a communication to the plant RTAC 512, and in turn, with, at 590, the plant RTAC 512 sending a communication to the utility RTAC 510) to indicate that the current state is islanding. By way of example, the ready to island Modbus signal may be set zero, thereby indicating to the utility that the plant is not ready to island (since the plant is already in islanded mode). Finally, at 592, the utility may send a communication that the plant indicating that islanding has concluded. Specifically, at 594, the utility RTAC 510 may change the Modbus signal to indicate that the islanding transition has concluded.

In this regard, in transitioning from grid-tied to islanded, the power output by the plant may be adjusted to match the amount of power provided to the microgrid loads. In the example above, while grid-tied, the plant may dispatch 10 MW to the utility and dispatching 2 MW to the microgrid customer loads. The amount of power output by the plant may be adjusted (e.g., reduced) to 2 MW to match the amount dispatched to the microgrid customer loads in the present example. Thereafter, one or more aspects of the grid (e.g., one or both of frequency or voltage) may also be measured to determine whether the one or more aspects of the grid are within tolerance (e.g., within a predetermined percentage, such as within 2% of predetermined tolerance values). The measurements of the one or more aspects of the grid may be performed on one or both of the grid side or the plant side. In the event that the one or more aspects are within tolerance, the plant may immediately transition to islanded. If not, the controller may wait (e.g., wait a predetermined amount of time) in order for the frequency/voltage to stabilize, after which, islanding may occur.

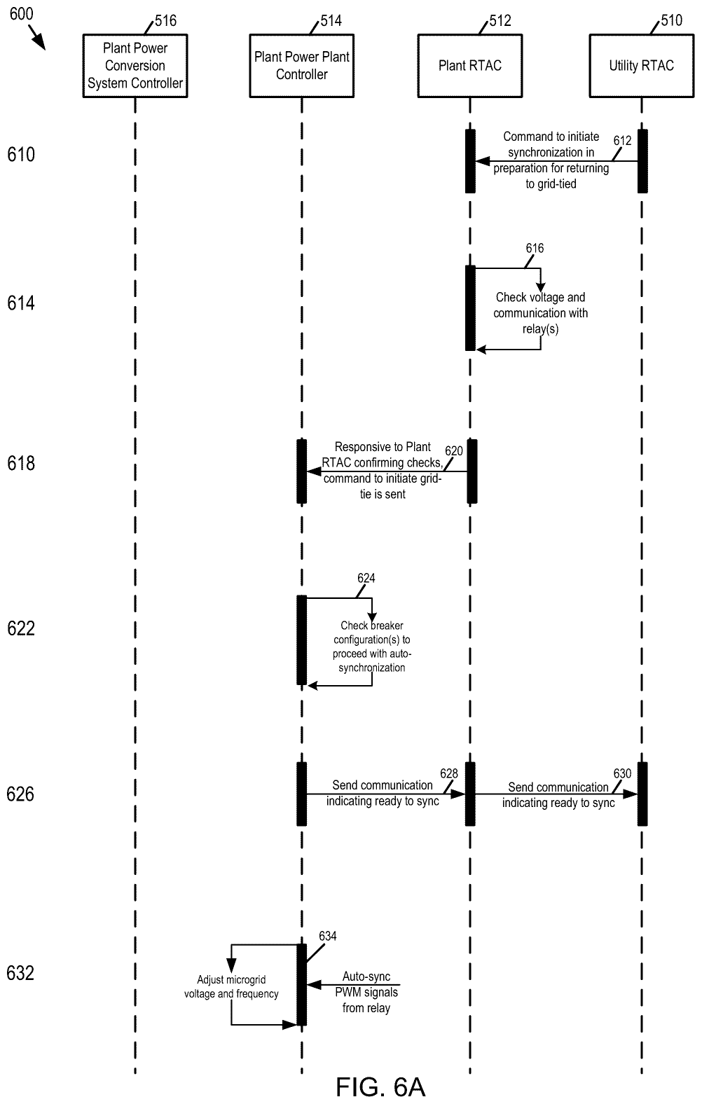

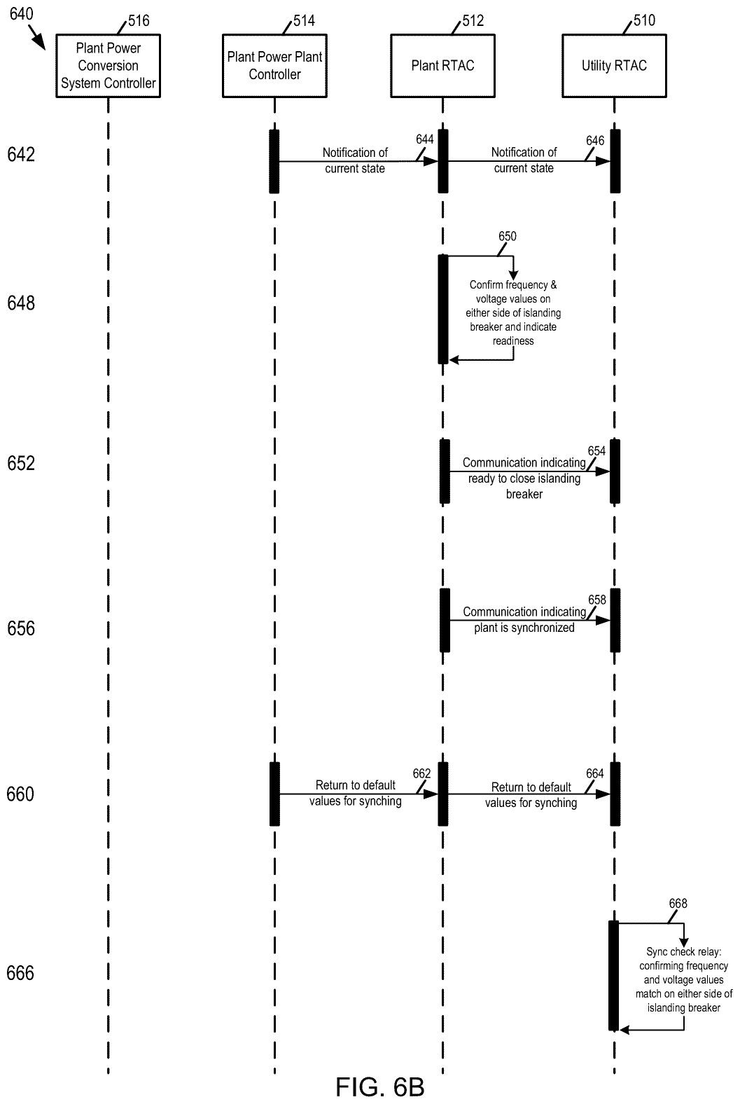

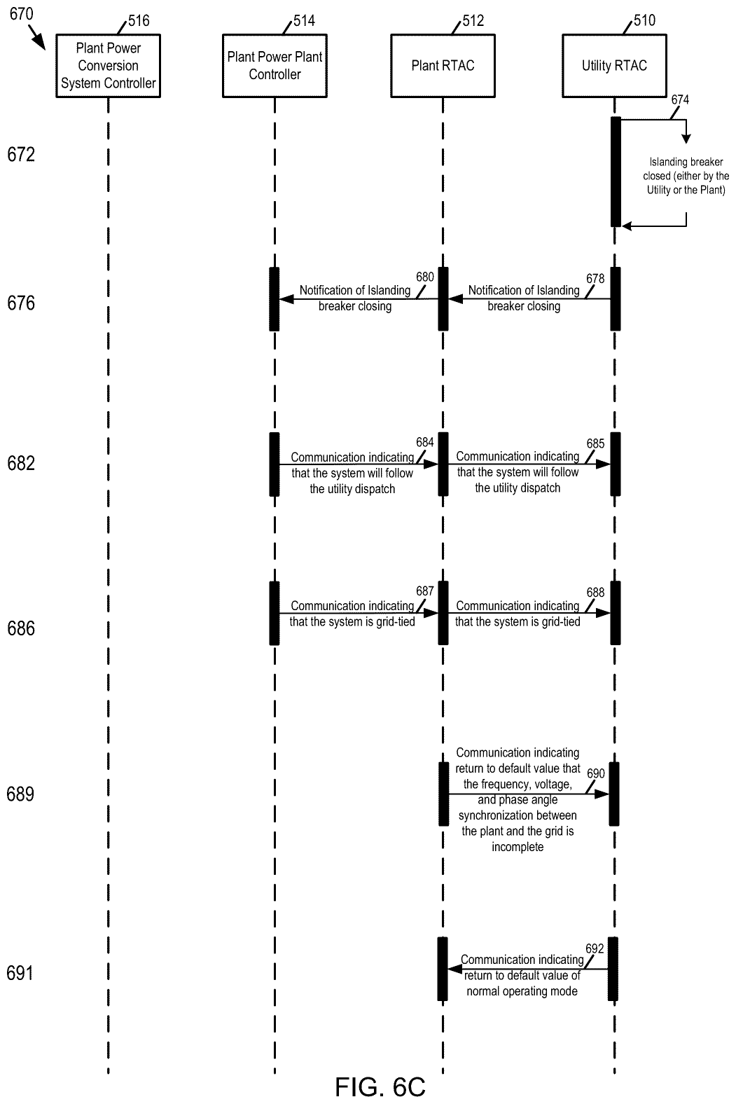

FIG. 6A-C is a sequence diagram 600, 640, 670 illustrating transitioning from islanded to grid-tied. As discussed above, the trigger to transition from islanded to grid-tied may be initiated by the utility (e.g., on the grid side) and/or by the plant (e.g., on the microgrid side). At 610, FIGS. 6A-C illustrate the utility RTAC 510 sending a command to the plant RTAC 512 to initiate synchronization in preparation for returning to grid-tied (see 612). After which, at 614, the plant RTAC 512 may perform one or more checks. As one example, at 616, the plant RTAC 512 may check voltage and communication with one or more relays (e.g., relay 468), which may be used for the reconnecting sequence. As another example, the plant RTAC 512 may check the status of the system (e.g., that the islanding breaker, such as breaker 438, is actually opened to determine whether the plant is actually islanded). If so, the sequence may proceed to 618, in which the plant RTAC 512 may communicate with one or more devices within the plant. For example, responsive to the checks performed at 614, at 620, the plant RTAC 512 may send a command to the plant PPC 514 to initiate auto-synchronization or resynchronization to initiate a return to grid-tied. In turn, at 622, the plant PPC 514 may perform one or more checks, such as at 624 checking the breaker configuration(s) in order to proceed with auto-synchronization. As one example, the plant PPC 514 may check the status of the system (e.g., that the islanding breaker, such as breaker 438, is actually opened to determine whether the plant is actually islanded). This may be duplicative of one or more checks performed at 614. Nevertheless, prior to reconnecting to the grid, certain checks may be performed multiple times by different devices within the plant. In this regard, in one or some embodiments, both the plant PPC 514 and the plant RTAC 512 may check the grid status. Alternatively, only one of the plant PPC 514 and the plant RTAC 512 may check the grid status (e.g., only the plant PPC 514 may check the grid status).

Responsive to passing the checks performed at 624, at 626, FIG. 6A illustrates a series of communications in preparation for grid-tying with, at 628, the plant PPC 514 sending a communication to the plant RTAC 512 indicating ready to sync, and in turn, with, at 630, the plant RTAC 512 sending a command to the utility RTAC 510 indicating ready to sync. At 632, the plant PPC 514 may adjust the microgrid voltage and/or frequency to match the grid. For example, at 634, one or more devices (e.g., relay 468) may measure the voltage and/or the frequency on both the microgrid side and the grid side as there may be differences in voltage and/or frequency. The measurements may be transmitted to the plant PPC 514. In turn, the plant PPC 514 may thereafter attempt to modify the voltage and/or frequency to match the grid side within a certain tolerance. For example, the plant PPC 514 may begin adjusting microgrid voltage and/or frequency according to the relay 468 auto-synchronization pulse width signals. In one or some embodiments, the auto-synchronizer relay 468 is configured to calculate the slip frequency difference between the microgrid side and the grid side. Based on this, relay 468 may send one or more signals to raise frequency, lower frequency, raise voltage, or lower voltage to the AES PPC through the pulse width modulation signal. In turn, the AES PPC may take the one or more signals as an input and may automatically follow the PWM signals to raise/lower frequency and/or voltage in order to adjust for the microgrid.

Responsive to confirming that the voltage and frequency are within the tolerance range on either side of the islanding breaker, at 642, FIG. 6B illustrates a series of communications indicating the current state including, at 644, the plant PPC 514 sending a communication to the plant RTAC 512 notifying the current state, and in turn, with, at 646, the plant RTAC 512 sending a command to the utility RTAC 510 notifying the current state.

At 648, additional confirmation on the plant side is performed. For example, at 650, the plant RTAC 512 may confirm the frequency and voltage values on either side of the islanding breaker are within tolerances and, if so, indicate readiness. At 652 and 656, the plant may send one or more communications in preparation for the grid to close the islanding breaker. For example, at 654, the plant RTAC 512 may send a communication to the utility RTAC 510 indicating readiness to close the islanding breaker. As another example, at 658, the plant RTAC 512 may send a communication to the utility RTAC 510 indicating that the plant is synchronized (e.g., with regard to frequency and voltage) to the grid. Though FIG. 6B illustrates two separate communications, a single communication may be sent to indicate readiness.

Further, at 660, the system may reset the system synch status, such as at 660, in which FIG. 6B illustrates a series of communications indicating the return to the default state, at 662, the plant PPC 514 sending a communication to the plant RTAC 512 at 664 notifying a return to the default values for synching, and in turn, with, at 646, the plant RTAC 512 sending a communication to the utility RTAC 510 notifying a return to the default values for synching.

Prior to the utility closing the islanding switch, at 666, the utility may again perform additional checks. For example, at 668, the utility, which may own and control the islanding breaker, may confirm that the frequency and voltage values on both sides of the islanding breaker are within tolerance. In particular, the utility may use relay 430 in order to perform the check. In this regard, the utility may perform additional checks (particularly when the islanding breaker is owned and/or operated by the utility, separate from the checks performed by the plant.

Alternatively, if the plant owns and/or operates the islanding breaker (e.g., relay 468 may control the islanding breaker), the plant PPC 514, in combination with relay 468, may: (1) examine the frequency and voltage in the grid and microgrid; and (2) simultaneously perform a sync check (e.g., measuring the difference between the grid and microgrid) and adjust the plant frequency and/or voltage to match the grid frequency and voltage. For example, the plant PPC 514 may adjust the frequency and voltage of the microgrid to match the grid. Alternatively, or in addition, while these adjustments are being performed, relay 468 may independently check the frequency and voltage on the grid and microgrid to see if they match. Once relay 468 determines that the frequency, voltage, and phase angle is within range, the relay 468 may close the islanding breaker.

At 672 in FIG. 6C, the islanding breaker may be closed. For example, if the islanding breaker is owned and/or controlled by the utility, at 674, the utility RTAC 510 may close the islanding breaker. At 676, a series of communications may be sent responsive to the closing of the islanding breaker. For example, at 678, the utility RTAC 510 may notify the plant RTAC 512 of the closing of the islanding breaker, and in turn, at 680, the plant RTAC 512 may notify the plant PPC 514 of the closing of the islanding breaker.

At 682, one or more communications may be sent indicating operations during grid-tic. For example, at 684, the plant PPC 514 may notify the plant RTAC 512 that the plant will follow utility dispatch. In turn, at 685, the plant RTAC 512 may notify the utility RTAC 510 that the plant will follow utility dispatch. At 686, one or more communications may be sent indicating that the system is grid-tied. For example, at 687, the plant PPC 514 may notify the plant RTAC 512 that the system is grid-tied. In turn, at 688, the plant RTAC 512 may notify the utility RTAC 510 that the system is grid-tied. Further, at 689, 691, one or more communications may be sent in preparation for the next closing of the islanding breaker. For example, at 690, the plant RTAC 512 may notify the utility RTAC 510 of a return to the default value indicating that the frequency, voltage, and phase angle synchronization between the plant and the grid is incomplete. Further, at 692, the utility RTAC 510 may notify the plant RTAC 512 that the plant is in normal operating mode with no planned reconnection event.

In all practical applications, the present technological advancement must be used in conjunction with a computer, programmed in accordance with the disclosures herein. Generally speaking, various parts may include computing functionality, such as any one, any combination, or all of: SCADA system (e.g., the plant SCADA system); relays; RTACs; communication functionality with the utility; controllers (plant PPC, plant PCS controller, etc.). Various types of communication functionality are contemplated. As one example, the communication functionality may comprise Internet communication, wired communication, wireless communication, communication via one or more protocols, etc. Merely by way of example, various devices disclosed in the present application may comprise a computer or may work in combination with a computer (e.g., executed by a computer), such as, for example, in block diagrams in FIGS. 1, 2A-B and 4A-B, in flow diagrams in FIGS. 3A-B, and in sequence diagrams in FIGS. 5A-B and 6A-C. With regard to the figures, computing functionality may be manifested in any one, any combination, or all of: controls 218; controls 240; PPC 241, inverter controller(s) 242, RTAC 143, control electronics 228, 233, 233, 235, 238, 246, 272, 276, 282, 286; utility RTAC 510; plant RTAC 512; plant PPC 514; or plant PCS controller 516. As such, computing functionality may be resident within any of the electronic devices discussed herein.

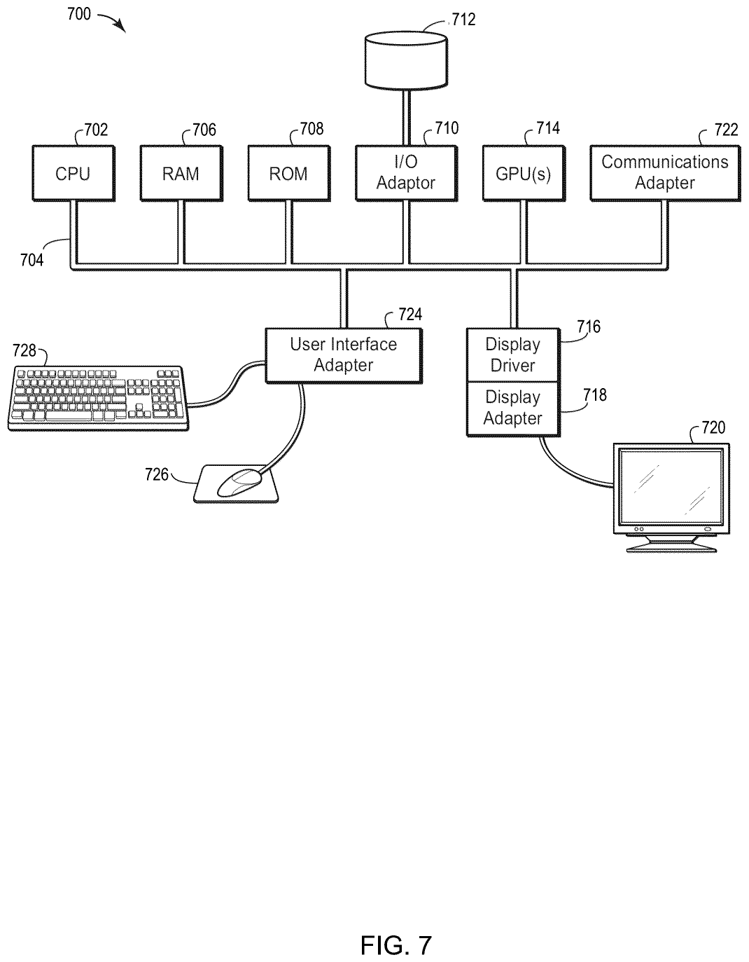

FIG. 7 is a diagram of an exemplary computer system 700 that may be utilized to implement methods, including the flow diagrams, described herein. A central processing unit (CPU) 702 is coupled to system bus 704. The CPU 702 may be any general-purpose CPU, although other types of architectures of CPU 702 (or other components of exemplary computer system 700) may be used as long as CPU 702 (and other components of computer system 700) supports the operations as described herein. Those of ordinary skill in the art will appreciate that, while only a single CPU 702 is shown in FIG. 7, additional CPUs may be present. Moreover, the computer system 700 may comprise a networked, multi-processor computer system that may include a hybrid parallel CPU/GPU system. The CPU 702 may execute the various logical instructions according to various teachings disclosed herein. For example, the CPU 702 may execute machine-level instructions for performing processing according to the operational flow described herein.

The computer system 700 may also include computer components such as non-transitory, computer-readable media. Examples of computer-readable media include computer-readable non-transitory storage media, such as a random-access memory (RAM) 706, which may be SRAM, DRAM, SDRAM, or the like. The computer system 700 may also include additional non-transitory, computer-readable storage media such as a read-only memory (ROM) 708, which may be PROM, EPROM, EEPROM, or the like. RAM 706 and ROM 708 hold user and system data and programs, as is known in the art. In this regard, computer-readable media may comprise executable instructions to perform any one, any combination, or all of the blocks in the flow charts in FIGS. 3A-B and in the sequence diagrams in FIGS. 5A-B and 6A-C. The computer system 700 may also include an input/output (I/O) adapter 710, a graphics processing unit (GPU) 714, a communications adapter 722 (e.g., a communication interface), a user interface adapter 724, a display driver 716, and a display adapter 718.

The I/O adapter 710 may connect additional non-transitory, computer-readable media such as storage device(s) 712, including, for example, a hard drive, a compact disc (CD) drive, a floppy disk drive, a tape drive, and the like to computer system 700. The storage device(s) may be used when RAM 706 is insufficient for the memory requirements associated with storing data for operations of the present techniques. The data storage of the computer system 700 may be used for storing information and/or other data used or generated as disclosed herein. For example, storage device(s) 712 may be used to store configuration information or additional plug-ins in accordance with the present techniques. Further, user interface adapter 724 couples user input devices, such as a keyboard 728, a pointing device 726 and/or output devices to the computer system 700. The display adapter 718 is driven by the CPU 702 to control the display on a display device 720 to, for example, present information to the user such as images generated according to methods described herein.

The architecture of computer system 700 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 700 may include various plug-ins and library files. Input data may additionally include configuration information.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting models discussed herein may be downloaded or saved to computer storage.

The following example embodiments of the invention are also disclosed:

### Embodiment 1

A method for transitioning a plant between grid-tied and islanded, wherein the plant includes at least one microgrid supplying power to one or more customer loads, wherein the plant when grid-tied is providing to or receiving power from at least a part of a grid that is operated by a utility, wherein the plant when islanded is disconnected from providing or receiving power to the at least a part of the grid, the method comprising:
responsive to an indication to transition the plant between grid-tied and islanded:
   performing one or more checks prior to the transition, the one or more checks comprising:
      for the transition from grid-tied to islanded: determining an amount of power provided to the grid and an amount of power provided to the one or more customers of the plant; or
      for the transition from islanded to grid-tied: determining, by the plant, whether sensed frequency, sensed voltage and sensed phase angle on both sides of the at least one islanding breaker is within a predetermined tolerance;
   responsive to performing the one or more checks prior to the transition, determining whether to perform one or more actions, the one or more actions comprising:
      for the transition from grid-tied to islanded: responsive to determining the amount of power provided to the grid and the amount of power provided to the one or more customers of the plant, modifying power output of the plant to be the amount of power provided to the one or more customers loads of the at least one microgrid; or
      for the transition from islanded to grid-tied: responsive to determining by the plant that the sensed frequency, the sensed voltage, and the sensed phase angle on both sides of the at least one islanding breaker are not within the predetermined tolerance, performing at least one action so that the sensed frequency, the sensed voltage, and the sensed phase angle on both sides of the at least one islanding breaker are within the predetermined tolerance; and
   after determining whether to perform the one or more actions and performing the one or more actions, causing the at least one islanding breaker to change its state thereby transitioning the plant between grid-tied and islanded.

### Embodiment 2

The method of embodiment 1:
wherein the transition is from grid-tied to islanded; and
wherein responsive to receiving the indication to transition the plant from grid-tied to islanded:
   the amount of power provided to the grid and the amount of power provided to the one or more customers of the plant is determined;
   the power output of the plant is modified to be the amount of power provided to the one or more customers loads of the at least one microgrid; and
   after modifying the power output of the plant to be the amount of power provided to the one or more customers loads of the at least one microgrid, the at least one islanding breaker is caused to be opened, thereby islanding the plant from the grid.

### Embodiment 3

The method of embodiments 1 or 2:

wherein modifying the power output of the plant to be the amount of power provided to the one or more customers loads of the at least one microgrid comprises modifying the power output to be within a predetermined tolerance of the amount of power provided to the one or more customers loads of the at least one microgrid.

### Embodiment 4

The method of any of embodiments 1-3:

wherein causing the at least one islanding breaker to open comprises the plant notifying the utility that the at least one islanding breaker is to be opened so that the utility commands the at least one islanding breaker to open.

### Embodiment 5

The method of any of embodiments 1-4:

wherein the plant notifying the utility that the at least one islanding breaker is to be opened further causes the utility to perform one or more additional checks prior to commanding the at least one islanding breaker to open.

### Embodiment 6

The method of any of embodiments 1-5:

wherein the one or more additional checks comprises verifying frequency and voltage are within the predetermined tolerance.

### Embodiment 7

The method of any of embodiments 1-6:
wherein the indication to transition the plant from grid-tied to islanded is received from the utility; and
wherein responsive to the plant receiving from the utility the indication to transition the plant from grid-tied to islanded, the plant: determines the amount of power provided to the grid and the amount of power provided to the one or more customers of the at least one microgrid; modifies the power output of the plant to be the amount of power provided to the one or more customers loads of the at least one microgrid; and causes the at least one islanding breaker to open, thereby islanding the plant from the grid.

### Embodiment 8

The method of any of embodiments 1-7:

wherein the indication to transition the plant from grid-tied to islanded is generated by the plant.

### Embodiment 9

The method of any of embodiments 1-8:

wherein causing the at least one islanding breaker to change its state thereby transitioning the plant from grid-tied to islanded comprises sending a communication from the plant to the utility indicating ready to island.

### Embodiment 10

The method of any of embodiments 1-9:

wherein the communication from the plant to the utility indicating ready to island is indicative to the utility to perform additional checks prior to the utility controlling at least one islanding breaker to transition the plant from grid-tied to islanded.

### Embodiment 11

The method of any of embodiments 1-10:
wherein the plant has performed verification that the sensed frequency and the sensed voltage on both sides of the at least one islanding breaker is within the predetermined tolerance prior to sending the communication from the plant to the utility indicating ready to island; and
wherein the communication from the plant to the utility indicating ready to island is indicative to the utility for the utility to verify that the sensed frequency and the sensed voltage on both sides of the at least one islanding breaker is within the predetermined tolerance.

### Embodiment 12

The method of any of embodiments 1-11:
wherein the transition is from islanded to grid-tied; and
wherein responsive to the indication to transition the plant from islanded to grid-tied:
   determining, by the plant, whether the sensed frequency, the sensed voltage and the sensed phase angle on both sides of the at least one islanding breaker is within the predetermined tolerance;
   responsive to determining by the plant that the sensed frequency, the sensed voltage, and the sensed phase angle on both sides of the at least one islanding breaker are not within the predetermined tolerance, performing the at least one action so that the sensed frequency, the sensed voltage, and the sensed phase angle on both sides of the at least one islanding breaker are within the predetermined tolerance; and
   responsive to the plant determining that the sensed frequency, the sensed voltage, and the sensed phase angle on both sides of the at least one islanding breaker is within the predetermined tolerance:
   performing at least one of:
      commanding the at least one islanding breaker to transition from islanded to grid-tied only after receiving from the utility confirmation that the utility determined that the sensed frequency, the sensed voltage, and the sensed phase angle on both sides of the at least one islanding breaker is within the predetermined tolerance; or
      notifying the utility that the sensed frequency, the sensed voltage, and the sensed phase angle on both sides of the at least one islanding breaker is within the predetermined tolerance in order to cause the utility to command the at least one islanding breaker to transition from islanded to grid-tied only after receiving from the utility confirmation that the utility determined that the sensed frequency, the sensed voltage, and the sensed phase angle on both sides of the at least one islanding breaker is within the predetermined tolerance.

### Embodiment 13

The method of any of embodiments 1-12:

wherein the plant, via at least two separate devices, determines whether the sensed frequency and the sensed voltage on both sides of the at least one islanding breaker is within the predetermined tolerance.

### Embodiment 14

The method of any of embodiments 1-13:
wherein the plant includes a plant real-time automation controller (RTAC) and a plant power plant controller (PPC); and
wherein both the plant RTAC and a plant PPC separately determine whether the sensed frequency and the sensed voltage on both sides of the at least one islanding breaker is within the predetermined tolerance.

### Embodiment 15

The method of any of embodiments 1-14:

wherein the at least one action comprises modifying at least one of the sensed frequency, the sensed voltage or the sensed phase angle of the plant.

### Embodiment 16

The method of any of embodiments 1-15:

wherein the at least one action comprises waiting at least a predetermined amount of time so that the sensed frequency, the sensed voltage, and the sensed phase angle on both sides of the at least one islanding breaker are within the predetermined tolerance.

### Embodiment 17

The method of any of embodiments 1-16:
wherein the transition is from grid-tied to islanded; and
wherein the transition is seamless in that there is no interruption in power to the one or more customer loads.

### Embodiment 18

The method of any of embodiments 1-17:
wherein the transition is from islanded to grid-tied; and
wherein the transition is seamless in that there is no interruption in power to the one or more customer loads.

### Embodiment 19

A plant configured to supply power to one or more customer loads and to supply the power to or receive the power from a grid that is operated by a utility, the plant comprising:
at least one microgrid configured to supply the power to the one or more customer loads;
communication functionality configured to communicate with the utility; and
at least one controller configured to:
   control the power supplied by the at least one microgrid to the one or more customer loads;
   responsive to an indication to transition the plant between grid-tied and islanded:
      perform one or more checks prior to the transition, the one or more checks comprising:
         for the transition from grid-tied to islanded: determining an amount of power provided to the grid and an amount of power provided to the one or more customers of the plant; or
         for the transition from islanded to grid-tied: determining, by the plant, whether sensed frequency, sensed voltage and sensed phase angle on both sides of the at least one islanding breaker is within a predetermined tolerance;
      responsive to performing the one or more checks prior to the transition, determine whether to perform one or more actions, the one or more actions comprising:
         for the transition from grid-tied to islanded: responsive to determining the amount of power provided to the grid and the amount of power provided to the one or more customers of the plant, modifying power output of the plant to be the amount of power provided to the one or more customers loads of the at least one microgrid; or
         for the transition from islanded to grid-tied: responsive to determining by the plant that the sensed frequency, the sensed voltage, and the sensed phase angle on both sides of the at least one islanding breaker are not within the predetermined tolerance, performing at least one action so that the sensed frequency, the sensed voltage, and the sensed phase angle on both sides of the at least one islanding breaker are within the predetermined tolerance; and
      after determining whether to perform the one or more actions and perform the one or more actions, cause the at least one islanding breaker to change its state thereby transitioning the plant between grid-tied and islanded.

### Embodiment 20

The method of embodiment 19:

wherein the at least one controller is configured to cause the at least one islanding breaker to change its state thereby transitioning the plant from grid-tied to islanded by sending a communication from the plant to the utility indicating ready to island.

### Embodiment 21

The method of embodiments 19 or 20:

wherein the communication from the plant to the utility indicating ready to island is indicative to the utility to perform additional checks prior to the utility controlling at least one islanding breaker to transition the plant from grid-tied to islanded.

### Embodiment 22

The method of any of embodiments 19-21:
wherein the at least one controller is configured to perform verification that the sensed frequency and the sensed voltage on both sides of the at least one islanding breaker is within the predetermined tolerance prior to sending the communication from the plant to the utility indicating ready to island; and
wherein the communication from the plant to the utility indicating ready to island is indicative to the utility for the utility to verify that the sensed frequency and the sensed voltage on both sides of the at least one islanding breaker is within the predetermined tolerance.

### Embodiment 44

A system comprising:
a processor; and
a non-transitory machine-readable medium comprising instructions that, when executed by the processor, cause a computing system to perform a method according to embodiments 1-18.

### Embodiment 45

a non-transitory machine-readable medium comprising instructions that, when executed by the processor, cause a computing system to perform a method according to embodiments 1-18.

What is claimed is:

1. A method for transitioning a plant between grid-tied and islanded, wherein the plant includes at least one microgrid supplying power to one or more customer loads, wherein the plant when grid-tied is providing to or receiving power from at least a part of a grid that is operated by a utility, wherein the plant when islanded is disconnected from providing or receiving power to the at least a part of the grid, the method comprising:
responsive to an indication to transition the plant between grid-tied and islanded:
performing one or more checks prior to the transition, the one or more checks comprising:
for the transition from grid-tied to islanded: determining an amount of power provided to the grid and an amount of power provided to the one or more customers of the plant; or
for the transition from islanded to grid-tied: determining, by the plant, whether sensed frequency, sensed voltage and sensed phase angle on both sides of the at least one islanding breaker is within a predetermined tolerance;
responsive to performing the one or more checks prior to the transition, determining whether to perform one or more actions, the one or more actions comprising:
for the transition from grid-tied to islanded: responsive to determining the amount of power provided to the grid and the amount of power provided to the one or more customers of the plant, modifying power output of the plant to be the amount of power provided to the one or more customers loads of the at least one microgrid; or
for the transition from islanded to grid-tied: responsive to determining by the plant that the sensed frequency, the sensed voltage, and the sensed phase angle on both sides of the at least one islanding breaker are not within the predetermined tolerance, performing at least one action so that the sensed frequency, the sensed voltage, and the sensed phase angle on both sides of the at least one islanding breaker are within the predetermined tolerance; and
after determining whether to perform the one or more actions and performing the one or more actions, causing the at least one islanding breaker to change its state thereby transitioning the plant between grid-tied and islanded.

2. The method of claim 1, wherein the transition is from grid-tied to islanded; and
wherein responsive to receiving the indication to transition the plant from grid-tied to islanded:
the amount of power provided to the grid and the amount of power provided to the one or more customers of the plant is determined;
the power output of the plant is modified to be the amount of power provided to the one or more customers loads of the at least one microgrid; and
after modifying the power output of the plant to be the amount of power provided to the one or more customers loads of the at least one microgrid, the at least one islanding breaker is caused to be opened, thereby islanding the plant from the grid.

3. The method of claim 2, wherein modifying the power output of the plant to be the amount of power provided to the one or more customers loads of the at least one microgrid comprises modifying the power output to be within a predetermined tolerance of the amount of power provided to the one or more customers loads of the at least one microgrid.

4. The method of claim 2, wherein causing the at least one islanding breaker to open comprises the plant notifying the utility that the at least one islanding breaker is to be opened so that the utility commands the at least one islanding breaker to open.

5. The method of claim 4, wherein the plant notifying the utility that the at least one islanding breaker is to be opened further causes the utility to perform one or more additional checks prior to commanding the at least one islanding breaker to open.

6. The method of claim 5, wherein the one or more additional checks comprises verifying frequency and voltage are within the predetermined tolerance.

7. The method of claim 2, wherein the indication to transition the plant from grid-tied to islanded is received from the utility; and
wherein responsive to the plant receiving from the utility the indication to transition the plant from grid-tied to islanded, the plant: determines the amount of power provided to the grid and the amount of power provided to the one or more customers of the at least one microgrid; modifies the power output of the plant to be the amount of power provided to the one or more customers loads of the at least one microgrid; and causes the at least one islanding breaker to open, thereby islanding the plant from the grid.

8. The method of claim 2, wherein the indication to transition the plant from grid-tied to islanded is generated by the plant.

9. The method of claim 2, wherein causing the at least one islanding breaker to change its state thereby transitioning the plant from grid-tied to islanded comprises sending a communication from the plant to the utility indicating ready to island.

10. The method of claim 9, wherein the communication from the plant to the utility indicating ready to island is indicative to the utility to perform additional checks prior to the utility controlling at least one islanding breaker to transition the plant from grid-tied to islanded.

11. The method of claim 10, wherein the plant has performed verification that the sensed frequency and the sensed voltage on both sides of the at least one islanding breaker is within the predetermined tolerance prior to sending the communication from the plant to the utility indicating ready to island; and
wherein the communication from the plant to the utility indicating ready to island is indicative to the utility for the utility to verify that the sensed frequency and the sensed voltage on both sides of the at least one islanding breaker is within the predetermined tolerance.

12. The method of claim 1, wherein the transition is from islanded to grid-tied; and
wherein responsive to the indication to transition the plant from islanded to grid-tied:
determining, by the plant, whether the sensed frequency, the sensed voltage and the sensed phase angle on both sides of the at least one islanding breaker is within the predetermined tolerance;
responsive to determining by the plant that the sensed frequency, the sensed voltage, and the sensed phase angle on both sides of the at least one islanding breaker are not within the predetermined tolerance, performing the at least one action so that the sensed frequency, the sensed voltage, and the sensed phase angle on both sides of the at least one islanding breaker are within the predetermined tolerance; and
responsive to the plant determining that the sensed frequency, the sensed voltage, and the sensed phase angle on both sides of the at least one islanding breaker is within the predetermined tolerance:
performing at least one of:
commanding the at least one islanding breaker to transition from islanded to grid-tied only after receiving from the utility confirmation that the utility determined that the sensed frequency, the sensed voltage, and the sensed phase angle on both sides of the at least one islanding breaker is within the predetermined tolerance; or
notifying the utility that the sensed frequency, the sensed voltage, and the sensed phase angle on both sides of the at least one islanding breaker is within the predetermined tolerance in order to cause the utility to command the at least one islanding breaker to transition from islanded to grid-tied only after receiving from the utility confirmation that the utility determined that the sensed frequency, the sensed voltage, and the sensed phase angle on both sides of the at least one islanding breaker is within the predetermined tolerance.

13. The method of claim 12, wherein the plant, via at least two separate devices, determines whether the sensed frequency and the sensed voltage on both sides of the at least one islanding breaker is within the predetermined tolerance.

14. The method of claim 13, wherein the plant includes a plant real-time automation controller (RTAC) and a plant power plant controller (PPC); and
wherein both the plant RTAC and a plant PPC separately determine whether the sensed frequency and the sensed voltage on both sides of the at least one islanding breaker is within the predetermined tolerance.

15. The method of claim 12, wherein the at least one action comprises modifying at least one of the sensed frequency, the sensed voltage or the sensed phase angle of the plant.

16. The method of claim 12, wherein the at least one action comprises waiting at least a predetermined amount of time so that the sensed frequency, the sensed voltage, and the sensed phase angle on both sides of the at least one islanding breaker are within the predetermined tolerance.

17. The method of claim 1, wherein the transition is from grid-tied to islanded; and
wherein the transition is seamless in that there is no interruption in power to the one or more customer loads.

18. The method of claim 1, wherein the transition is from islanded to grid-tied; and
wherein the transition is seamless in that there is no interruption in power to the one or more customer loads.

19. A plant configured to supply power to one or more customer loads and to supply the power to or receive the power from a grid that is operated by a utility, the plant comprising:
at least one microgrid configured to supply the power to the one or more customer loads;
communication functionality configured to communicate with the utility; and
at least one controller configured to:
control the power supplied by the at least one microgrid to the one or more customer loads;
responsive to an indication to transition the plant between grid-tied and islanded:
perform one or more checks prior to the transition, the one or more checks comprising:
for the transition from grid-tied to islanded: determining an amount of power provided to the grid and an amount of power provided to the one or more customers of the plant; or
for the transition from islanded to grid-tied: determining, by the plant, whether sensed frequency, sensed voltage and sensed phase angle on both sides of the at least one islanding breaker is within a predetermined tolerance;
responsive to performing the one or more checks prior to the transition, determine whether to perform one or more actions, the one or more actions comprising:
for the transition from grid-tied to islanded: responsive to determining the amount of power provided to the grid and the amount of power provided to the one or more customers of the plant, modifying power output of the plant to be the amount of power provided to the one or more customers loads of the at least one microgrid; or
for the transition from islanded to grid-tied: responsive to determining by the plant that the sensed frequency, the sensed voltage, and the sensed phase angle on both sides of the at least one islanding breaker are not within the predetermined tolerance, performing at least one action so that the sensed frequency, the sensed voltage, and the sensed phase angle on both sides of the at least one islanding breaker are within the predetermined tolerance; and
after determining whether to perform the one or more actions and perform the one or more actions, cause the at least one islanding breaker to change its state thereby transitioning the plant between grid-tied and islanded.

20. The plant of claim 19, wherein the at least one controller is configured to cause the at least one islanding breaker to change its state thereby transitioning the plant from grid-tied to islanded by sending a communication from the plant to the utility indicating ready to island.

21. The plant of claim 20, wherein the communication from the plant to the utility indicating ready to island is indicative to the utility to perform additional checks prior to the utility controlling at least one islanding breaker to transition the plant from grid-tied to islanded.

22. The plant of claim 21, wherein the at least one controller is configured to perform verification that the sensed frequency and the sensed voltage on both sides of the at least one islanding breaker is within the predetermined tolerance prior to sending the communication from the plant to the utility indicating ready to island; and
wherein the communication from the plant to the utility indicating ready to island is indicative to the utility for the utility to verify that the sensed frequency and the sensed voltage on both sides of the at least one islanding breaker is within the predetermined tolerance.
